(19) United States
(12) Patent Application Publication
(10) Pub. No.: US 2004/0156619 A1
(43) Pub. Date: Aug. 12, 2004

(54) Recording and reproducing apparatus

(76) Inventor: Katsuhiro Wada, Tokyo (JP)

Correspondence Address: ROBIN BLECKER & DALEY, 2ND FLOOR, 330 MADISON AVENUE, NEW YORK, NY, 10017, US

(21) Appl. No.: 10/771,794

(22) Filed: Feb. 4, 2004

(30) Foreign Application Priority Data
Feb. 7, 2003 (JP) 2003-031027

(51) Int. Cl. H04N 5/783

(52) U.S. Cl. 386/68; 386/111

(57) ABSTRACT

A reproducing apparatus reproduces moving image data for normal reproduction and image data for high-speed reproduction from a recording medium which records thereon a moving image data train including the encoded moving image data for normal reproduction which is encoded by using intra-frame coding and inter-frame coding, and the image data for high-speed reproduction, and multiplexes and outputs in a form of encoded data the reproduced moving image data for normal reproduction and the reproduced image data for high-speed reproduction.

### BACKGROUND OF THE INVENTION

1. Field of the Invention

The present invention relates to a recording and reproducing apparatus, particularly to the recording and reproducing apparatus which records and reproduces encoded digital image data on and from a tape-shaped recording medium.

2. Related Background Art

A digital VCR which encodes the image data to record and reproduce the encoded image data on and from magnetic tape has been known. In recent years, an apparatus in which the image data is encoded by using inter-frame coding format such as a MPEG system to be record and reproduce on and from the magnetic tape is also known.

One of such kinds of the apparatuses is described in Japanese Patent Application Laid-Open No. H09-214889 (corresponding to U.S. Pat. No. 6,292,621).

In the MPEG system, since difference between frames of the image data is encoded, the encoded data can not be decoded using only this difference data, and the image data of a reference frame is required for the decoding.

Since the amount of data of each frame is varied in the image data which is encoded in the MPEG system, a position where the data of each frame is recorded is not fixed on the magnetic tape. In the case where the image data which is encoded in the MPEG system and recorded is reproduced at high speed, since a track on the magnetic tape can not be correctly scanned with a magnetic head, all the pieces of the data recorded on the tape are not reproduced and the data is discretely reproduced.

Therefore, a possibility of obtaining both the difference data to which the inter-frame coding is performed and the data of the reference frame is extremely decreased, and only the image data of the frame to which the intra-frame coding is performed can be decoded in the high-speed reproduction, so that obtaining the good reproduced image becomes difficult.

In Japanese Patent Application Laid-Open No. H09-214889, it is considered that the good reproduced image is obtained even in the high-speed reproduction in such a manner that image data for high-speed reproduction is generated aside from the normal coding image data by using only the image data to which the inter-frame coding is performed and the image data for high-speed reproduction is recorded at the position which is scanned with the head on each track in the high-speed reproduction.

In Japanese Patent Application Laid-Open No. 2001-309306 (corresponding to US Patent Publication No. 2002003948), there is described a technique, in which the image data recorded using the MPEG system is reproduced and the image data is output in a form of encoded data.

However, Japanese Patent Application Laid-Open No. 2001-309306 discloses a configuration in which the data of a PES format of MPEG2 reproduced from the tape is converted into a TS format to output the data in the form of digital data, but does not consider processing for the case in which the image data for high-speed reproduction is recorded on the tape at all, while Japanese Patent Application Laid-Open No. H09-214889 consider such the processing.

Therefore, in the case where so-called digital dubbing in which the output data is received to be record on the tape as disclosed in Japanese Patent Application Laid-Open No. 2001-309306 is considered, in the apparatus on the recording side it is required to newly generate the image data for high-speed reproduction from the input data of the TS format to be recorded, so that efficiency is not good.

### SUMMARY OF THE INVENTION

It is an object of the invention to solve the above-described problems.

It is another object of the invention to be able to transmit and receive the moving image data for normal reproduction and the image data for high-speed reproduction while the moving image data for normal reproduction and the image data for high-speed reproduction are easily encoded.

In order to achieve the above objects, according to an aspect of the present invention, a reproducing apparatus of the invention comprises reproducing means for reproducing moving image data for normal reproduction and image data for high-speed reproduction from a recording medium which records thereon moving image data train including the moving image data for normal reproduction which is encoded by using intra-frame coding and inter-frame coding, and the encoded image data for high-speed reproduction, and an interface which multiplexes and outputs in a form of encoded data the moving image data for normal reproduction and the image data for high-speed reproduction, each of which is reproduced by the reproducing means.

Other objects and features of the invention will become more apparent from the following detailed description of a preferred embodiment of the invention taken in connection with the accompanying drawings.

### BRIEF DESCRIPTION OF THE DRAWINGS

FIG. 1 is a block diagram showing a configuration of a recording and reproducing apparatus to which the invention is applied;

FIGS. 2A and 2B show an elementary stream (ES) and a packetized elementary stream (PES);

FIG. 3 shows data which is recorded on tape;

FIG. 4 shows the packetized elementary stream (PES) and a transport stream (TS);

FIG. 5 shows TS data; and

FIG. 6 shows a state of the configuration in dubbing operation.

### DETAILED DESCRIPTION OF THE PREFERRED EMBODIMENTS

A preferred embodiment of the invention will be described below referring to the accompanying drawings.

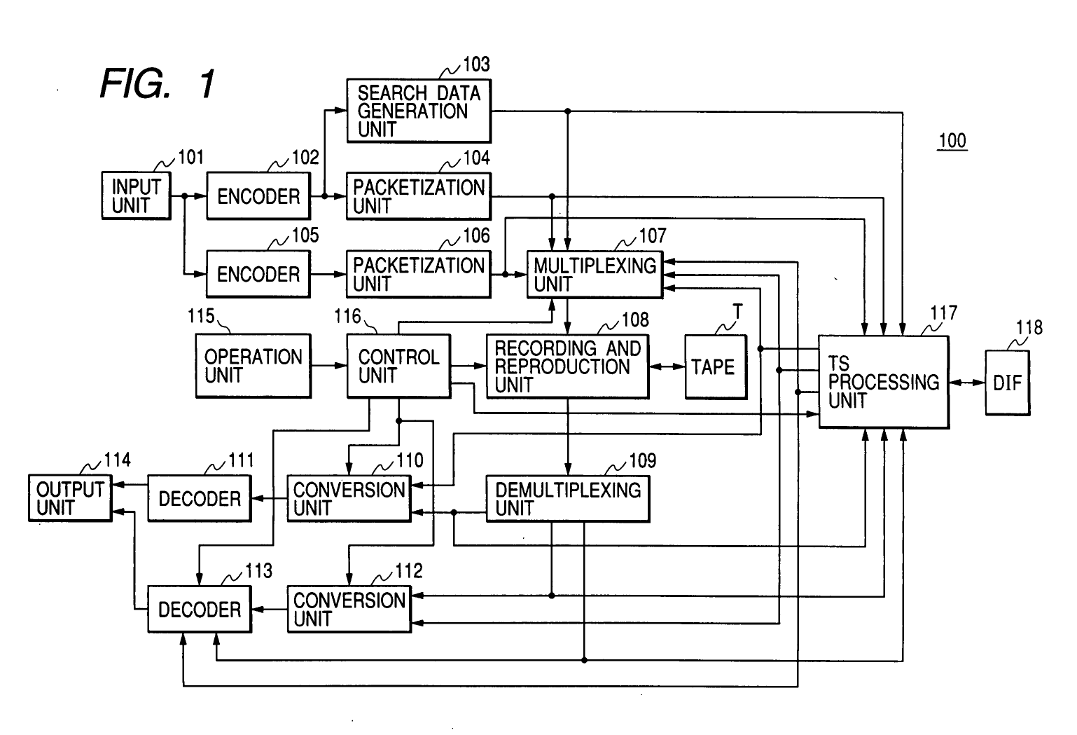

FIG. 1 shows the configuration of a recording and reproducing apparatus 100 to which the invention is applied. As described above, while the recording and reproducing apparatus 100 of FIG. 1 encodes the image data and the audio data pursuant to the MPEG system, the recording and reproducing apparatus 100 generates the image data for high-speed reproduction, to record and reproduce the data on and from a plurality of tracks on the tape.

At first, normal recording processing will be described.

The moving image signal and the audio signal, which are input from an input unit 101, are output to encoders 102 and 105 respectively. The encoder 102 encodes the input moving image signal pursuant to the MPEG2 format and outputs the encoded data to a search data generation unit 103 and a packetization unit 104. The data output from the encoder 102 is referred to as a video elementary stream (ES).

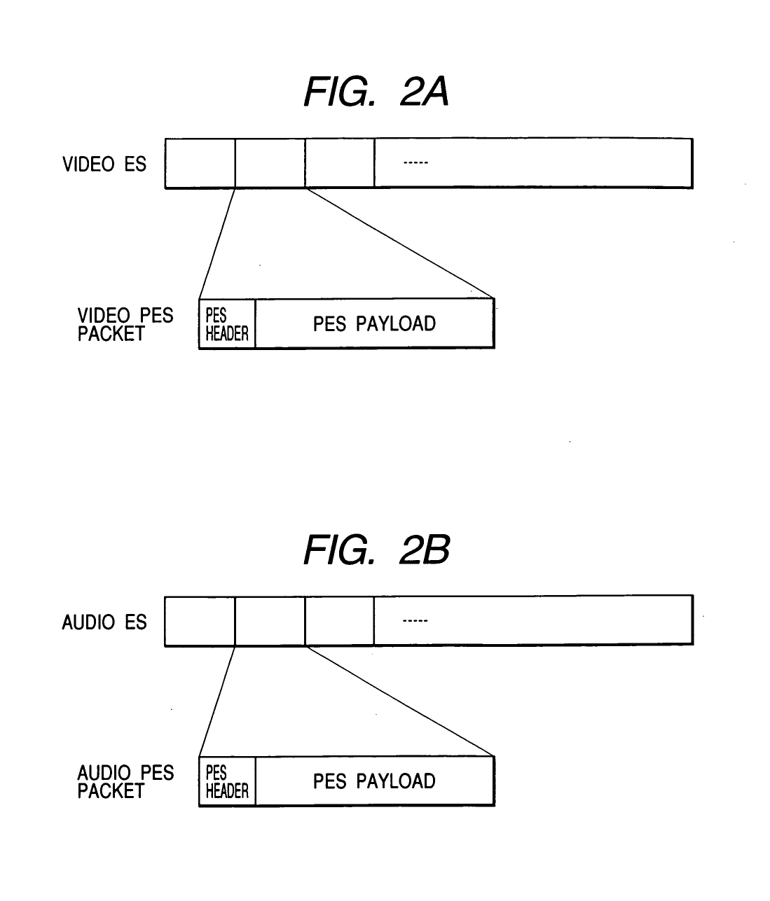

The packetization unit 104 divides the video ES data output from the encoder 102 into a plurality of blocks on predetermined data amount basis and forms a plurality of packets by adding a predetermined header to each block. The packet is referred to as a packetized elementary stream (PES) packet, and the data output from the packetization unit 104 is referred to as a video PES. FIG. 2A shows the video ES and the video PES packet. The packetization unit 104 generates the video PES from the video ES to output the video PES to a multiplexing unit 107.

In the MPEG2 format, the image data is encoded by switching among the intra-frame coding, forward predictive coding, and bidirectionally predictive coding on each frame basis. The search data generation unit 103 generates the image data for high-speed reproduction by using only the image data of the frame (I frame) to which the intra-frame coding is performed, among in the video ES output from the encoder 102, and the search data generation unit 103 outputs the generated data to the multiplexing unit 107.

The encoder 105 encodes the input audio signal pursuant to the MPEG audio coding system and outputs the encoded data to a packetization unit 106. The data output from the encoder 105 is referred to as an audio elementary stream (ES).

Similarly to the packetization unit 104, the packetization unit 106 divides the audio ES data output from the encoder 105 into the plurality of blocks on predetermined data amount basis and forms the plurality of packets by adding the predetermined header to each block. The data output from the packetization unit 106 is referred to as an audio PES. FIG. 2B shows the audio ES and the audio PES. The packetization unit 106 generates the audio PES from the audio ES to output the audio PES to a multiplexing unit 107.

According to a direction from a control unit 116, the multiplexing unit 107 divides the image data for high-speed reproduction into the plurality of blocks on predetermined data amount basis and adds the predetermined header to each block. The video PES output from the packetization unit 104, the audio PES output from the packetization unit 106, and the image data for high-speed reproduction output from the search data generation unit 103 are multiplexed to be output to a recording and reproduction unit 108 so that the block of the image data for high-speed reproduction is recorded at a position, where the tape is scanned with the head during the high-speed reproduction, in each track on tape T.

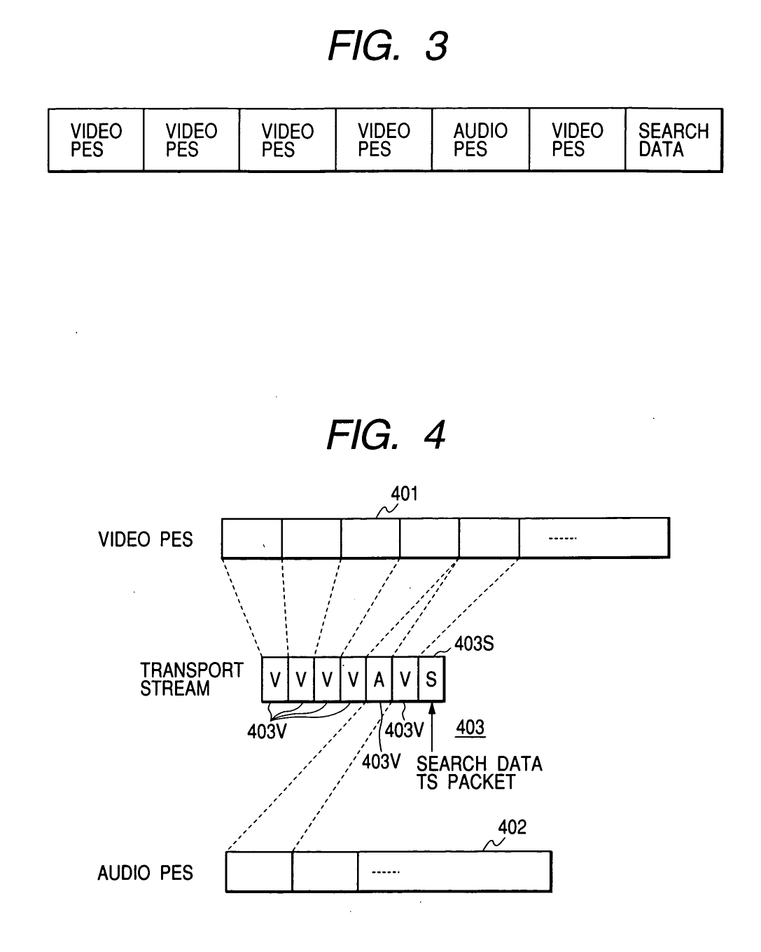

FIG. 3 shows the data output from the multiplexing unit 107.

The recording and reproduction unit 108 forms the plurality of tracks on the tape T to record sequentially the data output from the multiplexing unit 107, by using a rotational head.

Then, the operation in which the data is output from a digital interface during the normal recording will be described.

The video PES output from the packetization unit 104, the audio PES output from the packetization 106, and the image data for high-speed reproduction output from the search data generation unit 103 are also output to a transport stream (TS) processing unit 117.

According to the direction from the control unit 116, the TS processing unit 117 converts the video PES data, the audio PES data, and the image data for high-speed reproduction into the transport stream format of MPEG2 and outputs the converted data to a digital interface (DIF) 118.

The conversion processing performed by the TS processing unit 117 will be described below.

The TS processing unit 117 divides the video PES data, the audio PES data, and the image data for high-speed reproduction into the plurality of blocks on predetermined data amount basis and generates a 188-byte transport stream (TS) packet by adding the predetermined header (TS header) to each block. The TS processing unit 117 multiplexes the TS packet generated from the video PES, the TS packet generated from the audio PES, and the search data TS packet generated from the image data for high-speed reproduction at predetermined timing to generate TS.

FIG. 4 shows the multiplexing processing which is performed by the TS processing unit 117.

In FIG. 4, a reference numeral 401 denotes the video PES and a reference numeral 402 denotes the audio PES. In transport streams (TS) 403, a reference numeral 403V denotes the TS packet generated from the video PES 401, a reference numeral 403A denotes the TS packet generated from the audio PES 402, and a reference numeral 403S denotes the TS packet of the data for high-speed reproduction.

In TS, a 13-bit packet ID (PID) for identifying the data of each packet is added to a TS packet header. The TS processing unit 117 multiplexes and outputs at predetermined timing a program map table (PMT) showing contents of a program included in the packet of each PID and a program association table (PAT) for detecting PMT. PAT and PMT are referred to as program specific information (PSI). In particular, number 0 is allocated to PID of the TS packet having PAT.

In the present embodiment, predetermined values are independently allocated to PID of the video TS, PID of the audio TS, and PID of TS of the image data for high-speed reproduction, and PID of each TS packet is described in PMT. This allows the contents of the data to be detected only by detecting PID of each TS packet.

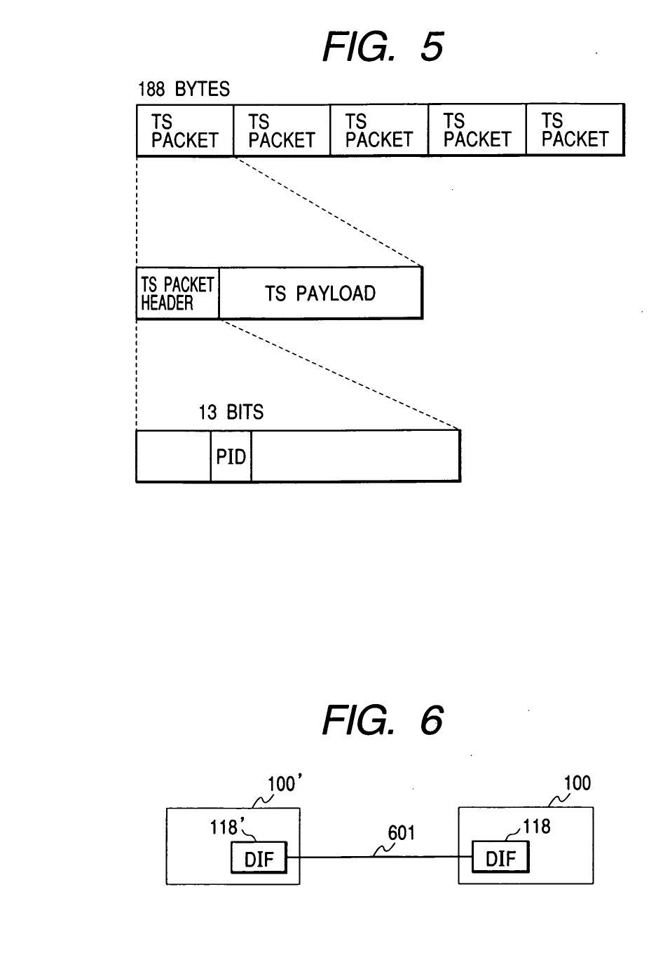

FIG. 5 shows the TS data, the TS packet, and the TS packet header.

DIF 118 outputs the TS data, which is output from the TS processing unit 117, to the outside of the apparatus pursuant to a format specified by an IEEE1394 standard.

The normal reproducing operation will be described below.

When the control unit 116 gives the direction of the normal reproduction, the recording and reproduction unit 108 reproduces the data train of the moving images recorded in the above-described manner from the tape T and outputs the data train of the moving images to a demultiplexing unit 109. The demultiplexing unit 109 detects the video PES, the audio PES, and the image data for high-speed reproduction from the reproduced data train of moving images, outputs the audio PES to a conversion unit 110, outputs the video PES to a conversion unit 112, and outputs the image data for high-speed reproduction to a decoder 113.

The conversion unit 110 detects each PES packet header from the output audio PES to generate the audio ES and outputs the audio ES to a decoder 111. The decoder 111 decodes the output audio ES to output the decoded audio ES to an output unit 114.

The conversion unit 112 detects each PES packet header from the video PES output from the demultiplexing unit 109 to generate the video ES and outputs the video ES to the decoder 113. In the normal reproducing operation, according to the direction from the control unit 116, the decoder 113 selects the video ES from among the video ES output from the conversion unit 112 and the data for high-speed reproduction output from the demultiplexing unit 109, to decode the video ES to output the decoded video ES to an output unit 114.

The output unit 114 converts the audio data output from the decoder 111 and the audio data output from the decoder 113 into the format suitable for the external devices and outputs the converted data.

Then, the processing in which DIF 118 outputs the data in the normal reproducing operation will be described.

The demultiplexing unit 109 also outputs the video PES, the audio PES, and the image data for high-speed reproduction, each of which is detected from the data train of images reproduced in the above-described manner, to a TS processing unit 117.

Even in the normal reproducing operation, similarly to the above recording operation, the TS processing unit 117 generates the TS packets from the video PES, the audio PES, and the image data for high-speed reproduction, according to the direction from the control unit 116, and the TS processing unit 117 multiplexes the generated TS packets to generate the TS data. DIF 118 outputs the TS data to the outside of the recording and reproducing apparatus 100.

That is to say, in the present embodiment, the moving image data, the audio data, and the image data for high-speed reproduction, each of which is reproduced from the tape T, are converted into the TS format and output it.

The high-speed reproduction processing will be described below.

When an operation unit 115 directs the high-speed reproduction, the control unit 116 directs the recording and reproduction unit 108 to reproduce the image data by feeding the tape T at predetermined speed faster than that of the normal reproduction.

The recording and reproduction unit 108 reproduces the image data by feeding the tape T at higher speed. At this point, the image data for high-speed reproduction which is recorded at the position corresponding to a scanning trajectory of the head in the high-speed reproduction in each track on the tape T is reproduced.

The demultiplexing unit 109 detects the image data for high-speed reproduction from the data output from the recording and reproduction unit 108 and outputs the image data for high-speed reproduction to the decoder 113. According to the direction from the control unit 116, the decoder 113 decodes the image data for high-speed reproduction output from the demultiplexing unit 109 and outputs the decoded image data for high-speed reproduction to the output unit 114. The control unit 116 also controls the conversion units 110 and 112 so as not to output the audio PES and the video PES, each of which is output from the demultiplexing unit 109, in the high-speed reproduction.

Then, the dubbing operation will be described, wherein the TS data, which is reproduced by the external device and output in the above-described manner, is input through DIF 118 to perform the recording.

In this case, as shown in FIG. 6, DIF 118 of the recording and reproducing apparatus 100 shown in FIG. 1 is connected to DIF 118′ of a recording and reproducing apparatus 100′ having the same configuration as the recording and reproducing apparatus 100 with an IEEE 1394 cable 601. The recording and reproducing apparatus 100′ is operated to reproduce image data to generate the TS data as in the above-described manner, and the TS data is output to DIF 118 of the recording and reproducing apparatus 100 through the DIF 118′.

In the recording and reproducing apparatus 100, the data reproduced by the recording and reproducing apparatus 100′ can be recorded on the tape T by instructing to record the data input from DIF 118.

The processing in which the data from DIF 118 is recorded by the recording and reproducing apparatus 100 will be described below.

DIF 118 inputs the TS data output from the recording and reproducing apparatus 100′ to output the TS data to the TS processing unit 117.

According to the direction from the control unit 116, the TS processing unit 117 detects PID of each of TS packets of the video PES, the audio PES, and the image data for high-speed reproduction on the basis of PAT and PMT in the input TS data, and the TS processing unit 117 detects the TS packet of each data on the basis of the detected PID. Then, the TS processing unit 117 generates the original video PES, the original audio PES, and the original image data for high-speed reproduction from each TS packet to output them to the multiplexing unit 107.

According to the direction from the control unit 116, the multiplexing unit 107 multiplexes the video PES, the audio PES, and the data for high-speed reproduction, each of which is output from the TS processing unit 117, so that the block of the image data for high-speed reproduction is recorded at the position, where the tape is scanned by the head during the high-speed reproduction, in each track on tape T. The multiplexing unit 107 outputs the multiplexed data to the recording and reproduction unit 108.

According to the direction of a recording start from the operation unit 115, the control unit 116 outputs the direction of start of the recording to the recording and reproduction unit 108. According to the direction of the recording start from the control unit 116, the recording and reproduction unit 108 records the data train of images from the multiplexing unit 107 on the tape T.

The processing in which the TS data input from DIF 118 is decoded and output will be described below.

When the control unit 116 gives the direction of the external input reproduction, in the same manner as in the case of the dubbing operation, the TS processing unit 117 detects the video PES, the audio PES, and the image data for high-speed reproduction from the TS data output from DIF 118, outputs the audio PES to the conversion unit 110, and outputs the video PES and the image data for high-speed reproduction to the decoder 113.

According to the direction from the control unit 116, the conversion unit 110 selects the audio PES output from the TS processing unit 117 to generate the audio ES and outputs the audio ES to the decoder 111. The decoder 111 decodes the audio ES output from the conversion unit 110 to output the decoded audio ES to the output unit 114.

According to the direction from the control unit 116, the conversion unit 112 selects the video PES output from the TS processing unit 117 to generate the video ES and outputs the video ES to the decoder 113. The decoder 113 selects the video ES from among the video ES output from the conversion unit 112 and the image data for high-speed reproduction output from the TS processing unit 117, and the decoder 113 decodes the video ES to output the decoded video ES to the output unit 114.

The output unit 114 outputs the audio data output from the decoder 111 and the image data output from the decoder 113 to the outside of the recording and reproducing apparatus 100.

As described above, according to the embodiment of the invention, the TS processing unit 117 converts the audio PES, the video PES, and the image data for high-speed reproduction, each of which is reproduced from the tape, into the TS data to output them through DIF 118, so that it is not necessary in the apparatus on the recording side that the image data for high-speed reproduction is newly generated even in the digital dubbing operation.

In the above embodiment, although the data for high-speed reproduction is always multiplexed and transmitted when transmitting the image data from DIF, for example it is also possible that the contents of the register managing whether the image data for high-speed reproduction is required or not is previously checked through DIF 118 and the image data for high-speed reproduction is transmitted without multiplexing the image data for high-speed reproduction by the TS processing unit 117 when the data for high-speed reproduction is not required.

Many widely different embodiments of the present invention may be constructed without departing from the spirit and scope of the present invention. It should be understood that the present invention is not limited to the specific embodiments described in the specification, except as defined in the appended claims.

What is claimed is:

1. A reproducing apparatus comprising:
reproducing means for reproducing moving image data for normal reproduction and image data for high-speed reproduction from a recording medium which records thereon moving image data train including the moving image data for normal reproduction which is encoded by using intra-frame coding and inter-frame coding and the image data for high-speed reproduction, and
an interface which multiplexes and outputs in a form of encoded data the moving image data for normal reproduction and the image data for high-speed reproduction, each of which is reproduced by the reproducing means.

2. A reproducing apparatus according to claim 1, wherein the interface converts the moving image data for normal reproduction and the image data for high-speed reproduction into a plurality of packets having a dada size of a predetermined amount respectively, and the interface multiplexes and outputs the plurality of packets.

3. A reproducing apparatus according to claim 2, wherein each of the plurality of packets includes ID data, and the interface allocates predetermined values different from each other to the ID data of the packet of the moving image data for normal reproduction and the ID data of the packet of the image data for high-speed reproduction.

4. A reproducing apparatus according to claim 1, further comprising controlling means for controlling whether the image data for high-speed reproduction is multiplexed and output or not, in accordance with a status of an apparatus to which the moving image data for normal reproduction and the image data for high-speed reproduction are to be output.

5. A reproducing apparatus according to claim 4, wherein the interface detects information stored in a predetermined register of the apparatus to which the moving image data for normal reproduction and the image data for high-speed reproduction are to be output, while the interface outputs the moving image data for normal reproduction and the image data for high-speed reproduction pursuant to an IEEE1394 standard, and the controlling means controls whether the image data for high-speed reproduction is multiplexed and output or not, in accordance with the information detected by the interface.

6. A reproducing apparatus according to claim 1, further comprising decoding means for decoding the moving image data for normal reproduction and the image data for high-speed reproduction, each of which is reproduced by the reproducing means, and for selecting and outputting one of the decoded moving image data for normal reproduction and the decoded image data for high-speed reproduction.

7. A reproducing apparatus according to claim 6, wherein the interface further receives a transmission data train, in which the moving image data for normal reproduction and the image data for high-speed reproduction are multiplexed in a form of encoded data, through a transmission line and detects the moving image data for normal reproduction and the image data for high-speed reproduction from the received transmission data train to output the detected data to the decoding means.

8. A reproducing apparatus according to claim 1, wherein the image data for high-speed reproduction includes only image data of a frame encoded by the intra-frame coding among the moving image data for normal reproduction.

9. A reproducing apparatus according to claim 1, wherein the recording medium includes a tape-shaped recording medium, and the moving image data for normal reproduction and the image data for high-speed reproduction are recorded in a plurality of tracks formed on the tape-shaped recording medium.

10. A reproducing apparatus according to claim 9, wherein the image data for high-speed reproduction is recorded at a position corresponding to a scanning trajectory of a reproducing head in high-speed reproduction within the plurality of tracks.

11. A recording apparatus comprising:
encoding means for encoding moving image data by using intra-frame coding and inter-frame coding to generate the moving image data for normal reproduction, and generating image data for high-speed reproduction by using a part of the moving image data for normal reproduction,
recording means for forming a plurality of tracks on a tape-shaped recording medium and recording the moving image data for normal reproduction and the image data for high-speed reproduction, each of which is generated by the encoding means, in the plurality of tracks; and
an interface which multiplexes and outputs in a form of encoded data the moving image data for normal reproduction and the image data for high-speed reproduction, each of which is generated by the encoding means.

12. A recording apparatus according to claim 11, wherein the recording means records the image data for high-speed reproduction at a predetermined position decided in the each track.

13. A recording apparatus according to claim 12, wherein the recording means records the image data for high-speed reproduction at a position corresponding to a scanning trajectory of a head in high-speed reproduction within the plurality of tracks.

14. A recording apparatus according to claim 11, wherein the interface converts each of the moving image data for normal reproduction and the image data for high-speed reproduction into a plurality of packets having a dada size of a predetermined amount and multiplexes and outputs the plurality of packets.

15. A recording apparatus according to claim 14, wherein each of the plurality of packets includes ID data, and the interface allocates predetermined values different from each other to the ID data of the packet of the moving image data for normal reproduction and an ID data of the packet of the image data for high-speed reproduction.

16. A recording apparatus according to claim 11, wherein the interface further receives a transmission data train, in which the moving image data for normal reproduction and the image data for high-speed reproduction are multiplexed while are encoded, from an external apparatus, and the recording means further records the moving image data for normal reproduction and the image data for high-speed reproduction, each of which is received by the interface.

17. A recording apparatus according to claim 11, wherein the encoding means generates the image data for high-speed reproduction by using only image data of a frame encoded by the intra-frame coding among the moving image data for normal reproduction.

18. A reproducing apparatus comprising: reproducing means for reproducing image data for normal reproduction and image data for high-speed reproduction from a recording medium on which a plurality of tracks are formed, in which tracks a moving image data train including the moving image data for normal reproduction which is encoded pursuant to a packetized elementary stream format of MPEG2, and the image data for high-speed reproduction corresponding to the moving image data for normal reproduction; and
an interface which multiplexes and outputs in a form of the transport stream format of MPEG2 the moving image data for normal reproduction of a packetized elementary stream format and the image data for high-speed reproduction of the packetized elementary stream format, each of which is reproduced by the reproducing means.

19. A reproducing apparatus according to claim 18, wherein the interface allocates values different from each other to a packet ID of a transport stream packet of the moving image data for normal reproduction and a packet ID of the transport stream packet of the image data for high-speed reproduction.

20. A reproducing apparatus comprising: reproducing means for reproducing moving image data for normal reproduction and image data for high-speed reproduction from a recording medium which records thereon a moving image data train including the encoded moving image data for normal reproduction and the image data for high-speed reproduction which is generated by using a part of the moving image data for normal reproduction;
decoding means for decoding the moving image data for normal reproduction and the image data for high-speed reproduction, each of which is reproduced by the reproducing means, the decoding means outputting the moving image data for normal reproduction in a normal reproducing mode and selecting and outputting the image data for high-speed reproduction in a rapid reproducing mode; and
an interface which multiplexes and output in a form of encoded data the moving image data for normal reproduction and the image data for high-speed reproduction each of which is reproduced by the reproducing means.
